(19) United States
(12) Patent Application Publication
(10) Pub. No.: US 2004/0242208 A1
(43) Pub. Date: Dec. 2, 2004

(54) Payment system and method for mobile communication services

(76) Inventor: Mordechai Teicher, Hod Hasharon, IL (US)

Correspondence Address: DANIEL J SWIRSKY, PO BOX 2345, BEIT SHEMESH, 99544, IL

(21) Appl. No.: 10/477,401

(22) PCT Filed: May 7, 2002
(86) PCT No.: PCT/IL02/00356

Related U.S. Application Data
(60) Provisional application No. 60/290,062, filed on May 11, 2001.

(51) Int. Cl. H04M 11/00

(52) U.S. Cl. 455/414.1; 455/403

(57) ABSTRACT

A system and method for payment for mobile communication services over commercial public networks. A mobile telephone is equipped with a payment unit capable of paying for mobile communications services at the time such services are furnished, and a base station is provided with a point-of-sale terminal capable of receiving payment for such services. Payment is made in the form of generally-accepted banking instruments which can be stored and transferred in electronic form, such as credit charges, debit charges, electronic stored value, electronic funds transfer, and so forth.

### FIELD OF THE INVENTION

The present invention relates to financial payment in conjunction with mobile communications, and, more particularly, to a mobile telephone equipped with a payment unit

### BACKGROUND OF THE INVENTION

The widespread global acceptance of mobile communications has created a situation where the current majority of telephones are mobile telephones. In addition, people today are themselves more mobile than ever before, and this has resulted in an upsurge in the extent of the geographical region from which the average mobile telephone is used. International travelers, for example, frequently carry their mobile telephones with them when they go abroad, and they expect to use their mobile telephones to initiate and receive calls wherever they are, on a world-wide basis.

The principles of the invention are illustrated in terms of mobile telephony, but apply to all forms of mobile communications over public commercial networks.

The term “mobile telephone” herein denotes any device capable of establishing and maintaining two-way wireless communication over a commercial public communications network. Non-limiting examples include cellular telephones and cellular data devices, personal digital appliances (also known as “personal digital assistants”, or PDA's) with cellular data communications capabilities, and wireless data terminals and facsimile devices capable of two-way communication over a commercial public communications network. For purposes of the present invention, telephony is not limited to voice communication, but also involves personal data communications in general, including Internet and facsimile communication; and the providing of audio signals of any kind, including music and non-interactive one-way communication, such as news, entertainment, and other information. The term “mobile telephony” herein denotes telephony involving a mobile telephone, and the term “mobile telephony session” herein denotes a specific mobile telephony connection, which can exist over a period of time. The term “mobile customer” herein denotes any individual or organization which operates or utilizes a mobile telephone. The term “mobile network” herein denotes any communications network which is in whole or in part devoted to mobile telephony.

The term “land-line telephony” herein denotes traditional telephony based on wires from a central office to subscriber locations, as distinct from mobile telephony, which is based on wireless connections.

The term “service provider” herein denotes any business or organization which operates a commercial public communications network or any part thereof, and which furnishes communications services to mobile customers on a commercial basis. The term “mobile network operator” herein denotes any business or organization which administers a mobile network or any substantial part thereof In particular, a mobile network operator can also encompass, or perform the functions of, a service provider of mobile telephone services. The term “mobile virtual network operator” herein denotes a mobile network operator which does not have ownership of the service provider physical infrastructure of a mobile network, but which manages service provider facilities through contractual relationships with independent service providers.

A mobile telephone based on cellular technology must establish contact with a local ground-based cellular network in order to receive or initiate a call. Because of the extensive geographical areas that must be covered, it has been necessary to establish a large number of these local ground-based cellular networks, which are owned and operated by various independent service providers and mobile network operators.

Unlike telephony based on land-lines, the billing and payment arrangements required for mobile telephony are complex and pose a special challenge.

For land-based lines, collecting fees for telephone service has never been especially difficult. The service provider (the “telephone company”) installs physical wiring to the place of service and has complete control over the operability of the system. For the most part, customers are therefore highly motivated to comply with the service provider's established billing and payment procedures, which are de-facto requirements for obtaining and maintaining service. The credit-worthiness of the average customer has thus never been an important consideration for the service provider. At worst, in questionable cases, the customer may have to post a deposit with the service provider, and in those rare occurrences where customers are delinquent on their bills, the amount in arrears may usually be minimized by prompt curtailment of service. Moreover, the customer who is delinquent in the payment of a considerable amount can usually be easily located or traced, and it has traditionally been a straightforward matter for the service provider to rely on standard legal remedies in these very rare cases.

None of the above favorable billing, payment, and collection aspects of land-line telephony fees, however, apply in the case of mobile telephony service. Mobile telephones are a commodity item, and activation of a mobile telephone does not involve the traditional installation required for a land-line telephone. By the very nature of mobile telephony, there is no “location” of service, and the customers therefore tend to be less well-known to the service provider. Nevertheless, most mobile customer relationships tend to follow the traditional model, which is illustrated in FIG. 1. A mobile customer 101 having a mobile telephone 103 arranges for mobile telephony service with a mobile network operator 105, who administers a mobile network which includes a service provider 107 having a base station (also referred to as a “base transceiver station” or “BTS”) 109. Base station 109 is thus also part of the mobile network. Within the local geographic region (“cell”) served by base station 109, customer 101 may use mobile telephone 103 to establish a two-way mobile telephony session 111 via radio connection with base station 109.

Because of lack of a physical location, as previously noted, billing and fee collection is a greater challenge in mobile telephony than in traditional land-line telephony, and so, of necessity, the billing and payment patterns for mobile telephony have been forced to develop in two directions:

1. credit accounts, where mobile customer 101 must establish credit with mobile network operator 105 as the principal service provider, who has primary responsibility for the payment of all mobile fees incurred by the customer, and who presents mobile customer 101 with an invoice (or “bill”) 113 on a regular basis to cover all services rendered; or, alternatively,

2. prepaid accounts, where mobile customer 101 purchases a certain amount of service in advance from mobile network operator 105 for a prepaid account 115, and can consume this pre-purchased service until exhausted or replenished (by an additional paid purchase). Unlike traditional land-line telephony, where prepaid accounts are rare, in mobile telephony these prepaid accounts are very common and in certain markets are used by more than half of the mobile customer base.

A major factor that distinguishes mobile telephony from land-line telephony is the practice of “roaming”, whereby a mobile customer uses a mobile telephone in an area where he or she has not established a billing and payment arrangement with a mobile network operator. Roaming greatly complicates the financial arrangements, especially where the roaming is international. When roaming, in fact, the customer is usually completely unaware of the identify of the service provider. In marketing mobile telephone services, the service providers would like customers to feel free to use their mobile telephones without having to be concerned about who the service provider may be. The ideal marketing arrangement, in fact, is that customers feel free to use their mobile telephones from any location without having to be aware that service providers even exist. It follows that in roaming situations, most customers will not have established any relationship whatsoever with the local service provider, and the local service provider will have to provide service for whatever customers are in the local service region without having an opportunity to establish the customer's credit-worthiness or trustworthiness in paying for services rendered.

FIG. 2 illustrates the business complexities introduced by roaming. Here, mobile customer 101 travels with mobile telephone 103 to a geographic region that is not served by mobile network operator 115, with whom mobile customer 101 has established a per-existing financial relationship, as previously detailed. Instead, when mobile customer 101 uses mobile telephone 10X, a mobile telephony session 205 is established with a base station 203 operated by a service provider 201. Fees for services furnished by service provider 201 cannot be sent to mobile customer 101, because there is no relationship between service provider 201 and mobile customer 101. Mobile customer 101, in fact, may not know who service provider 201 is, and service provider 201 may not know anything about mobile customer 101, other than that he is using mobile telephone 103, which is identified as having been activated by mobile network operator 105. Consequently, service provider 201 must turn to mobile network operator 105 for payment of fees, and therefore sends an invoice 207 to mobile network operator 105 for services rendered. Mobile network operator 105, in turn, includes a charge for the roaming usage in an invoice 209, which is sent to mobile customer 101.

As noted above, the roaming factor complicates billing and payment, and this is true even in the case of credit and prepaid accounts. An undesirable condition that commonly occurs in roaming situations is illustrated in FIG. 3. Here, mobile customer 101 is attempting to use mobile telephone 103 in an area where mobile network operator 105 has no agreements for providing local service. A service provider 301 operating a base station 303 establishes contact with mobile telephone 103, and determines that mobile telephone 103 has been activated by mobile network operator 105. Unlike the successful roaming situation shown in FIG. 2, service provider 301 realizes that without a pre-existing billing arrangement with mobile network operator 105, it is impossible to charge for services furnished. Service provider 301, like service provider 201 (FIG. 2), has no familiarity with mobile customer 101. But unlike service provider 201, however, service provider 301 has no agreement for the payment of fees and charges. Consequently, service provider 301 is unable to provide services to mobile customer 101, and hence a mobile telephony session 305 is denied. It is to be emphasized that mobile telephone 103 is technically capable of establishing a telephonic communication with base station 303, but is unable to do so simply because there is no way for service provider 301 to charge for services furnished.

There is thus a widely recognized need for, and it would be highly advantageous to have, a means of payment for mobile telephony services which does not depend on the existence of any prior arrangement between the user and provider of such services. This goal is met by the present invention.

### SUMMARY OF THE INVENTION

The present invention provides for a mobile telephone having a capability of making payments by universally-accepted negotiable banning payment instruments that can be transmitted in electronic form, and a service-providing system capable of accepting such banking instruments in electronic form. Because of the nature of the payment instruments, payment for mobile telephony services can be made by the mobile telephone at the time those services are utilized. The service provider is compensated as services are utilized and the financial transaction is completed at that time. Thus, there is no requirement for any prior financial arrangements between the user and the service provider.

FIG. 4 illustrates payment for mobile telephony services according to the present invention, which is free from the prior art limitations discussed above. In this approach, mobile customer 101 uses a mobile telephone 402 to establish a mobile telephony session 409 with a service provider 401 having a base station 403. The technical details for establishing mobile telephony between mobile telephone 402 and base station 403, and the interaction of mobile customer 101 are identical to the prior art schemes previously discussed regarding mobile telephone 103 and base stations 109, 203, and 303 (FIG. 1, FIG. 2, and FIG. 3). The initially-encountered difference between the present invention and the prior art involves the identification and validation of mobile telephone 402 by service provider 401. The identification and validation protocol according to the present invention will be described in detail below, but at this point it is sufficient to note that service provider 401 is able to determine that mobile telephone 402 is capable of providing payment for mobile services directly to service provider 401 at the time those services are rendered. Service provider 401 therefore authorizes the establishing of mobile telephony session 409, and mobile customer 101 is thus able to use mobile telephone 402 in the region served by service provider 401.

Turning briefly to FIG. 5, it is seen that mobile telephone 402 is able to provide payment for mobile services directly to service provider 401 at the time those services are rendered because mobile telephone 402 is equipped with a payment unit 501, as will be further discussed below. Furthermore, payment unit 501 identifies mobile telephone 402 and validates to service provider 401 that mobile telephone 402 is capable of paying upon request for mobile services at the time those services are rendered.

Turning briefly to FIG. 6, it is seen that service provider 401 is able to receive payment for mobile services directly from mobile telephone 402 at the time services are rendered because service provider 401 is furnished with a point-of-sale unit (POS) 601, as will be further discussed below. Furthermore, point-of-sale unit 601 identifies service provider 401 to mobile telephone 402 as being capable of receiving payment for mobile services at the time those services are rendered, and is also capable of presenting requests for payment to mobile telephone 402 as mobile services are used.

The term “point-of-sale” terminal, or “POS”, herein denotes any device or facility capable of receiving, storing, transferring, and accounting payment instruments that can be represented, stored, and transferred in electronic form. Such a facility may be within a separate device, or may be combined with another device. The POS, for example, may be embodied in software within an existing computer operated by the service provider.

Returning to FIG. 4, it is seen that the financial payment involves a financial institution 405 associated with service provider 401, and a financial institution 407 associated with mobile customer 101. Financial institution 405 and financial institution 407 are in general different financial institutions, but because they are established in accordance with the financial industry, they are able to interact and process financial transactions between them via a pre-existing banking channel 415, which is part of the existing conventional banking system. The scope of banking channel 415 encompasses local, regional, national, and international financial transactions of any amount, and it is well known that it is a more-or-less routine matter for virtually any recognized financial institution anywhere on earth to establish a channel such as banking channel 415 with virtually any other recognized financial institution. Thus, the respective geographical locations and particular choices for financial institution 405 and financial institution 407 are not critical, provided that both are recognized as financial institutions by the banking industry in general.

During the course of mobile telephony session 409, various charges for mobile telephony service will be incurred by the use of mobile telephone 402. According to the present invention, these charges are billed and paid as they accrue, as will be further discussed below. Service provider 401 will periodically send a request for payment, such as a request for payment 411 to mobile telephone 402, immediately after which mobile telephone 402 will return payment, such as a payment 413, to service provider 401. Payment 413 originates from payment unit 501 (FIG. 5) and is stored in point-of-sale unit 601 (FIG. 6). Periodically, accumulated payments 414 stored in point-of-sale unit 601 are sent by service provider 401 to financial institution 405 for credit to the account of service provider 401, and in this manner service provider 401 is compensated for the rendering of mobile telephony services. Among accumulated payments 414 is payment 413 from mobile telephone 402, and financial institution 405 may eventually process payment 413 for settlement, via banking channel 415 to financial institution 407. Payment 413 would then be deducted from the account of mobile customer 101 at financial institution 407.

The methods of financial settlement as mentioned above are well-known Certain variations in financial payment are covered below in discussions of the preferred embodiments of the invention. Other methods of financial payment relevant to the present invention are disclosed in U.S. Pat. No. 5,744,787 to the present inventor, which is incorporated by reference for all purposes as if fully set forth herein.

It is to be emphasized that all payments according to the present invention, such as payment 413 and accumulated payments 414, are payments made by universally-recognized banking instruments which are capable of being stored and transmitted electronically, non-limiting examples of which include credit charges, debit charges, electronic funds transfer, and electronic stored value.

In contrast, certain prior art schemes for payment involving a mobile telephone are based on proprietary payment techniques and do not involve universally-recognized banning instruments. An example of this is illustrated in FIG. 7. Mobile customer 101 uses a mobile telephone 701 to make a purchase from a vending machine 703. By special arrangement with a service provider 702 who provides mobile telephony services for mobile telephone 701, it is possible to make certain purchases using mobile telephone 701. In this particular example, mobile customer 101 purchases a beverage 707 from vending machine 703. The precise manner in which this is done depends on the technical details by which the scheme is implemented. One possibility is afforded by utilizing an infra-red link 705, with which many modem mobile telephones are equipped. In this case, mobile telephone 701 communicates with vending machine 703 via infra-red link 705 to initiate the purchase. Another possibility is that service provider 702 has a separate communication link with vending machine 703, such as by a cellular link, and that mobile telephone 701 either establishes cellular communications with vending machine 703 directly, or indirectly through a mobile telephony session 706 with service provider 702. There are also other technical arrangements for initiating the purchase. Regardless of how the purchase is initiated, however, in such a scheme, payment for the purchase is ultimately made by some sort of credit arrangement between the owner of vending machine 703 and service provider 702, whereupon the vendor (the merchant, in this case the owner of vending machine 703) is compensated by service provider 702, who is in turn compensated by mobile customer 701.

The important distinction to note in all such prior art payment schemes involving mobile telephony is that they all require a pre-arranged financial relationship between the service provider and the vendor. This is because all such prior art schemes employ financial payment methods which are proprietary to the service provider. In contrast, payment according to the present invention is made via universally-recognized financial payment instruments supported by a wide-spread banking community.

In a variation on the above prior-art scheme, certain mobile telephones are provided with a slot for the mobile customer to insert a standard banking “smart card”. Although this provides a mobile telephone with a payment unit capable of making a payment with a universally-recognized payment instrument, such a payment scheme is implemented in the prior art only for allowing the mobile customer to make standard purchases (such as those illustrated in FIG. 7) via his or her mobile telephone. Prior art schemes do not permit making payments on the initiative of the mobile telephone itself, for the purpose of paying for mobile telephony services.

Billing Versus Payment

There is another fundamental difference between the present invention and prior art payment methods and systems for mobile telephony services. In the prior-art, mobile telephony services are billed to the mobile customer by the service provider as they are provided. The terms “bill”, “billed”, and “billing” herein denote the accruing of future charges to a pre-established mobile customer credit account, or the diminishing of a prepaid mobile customer debit account.

In the case of a credit account, as the mobile customer utilizes the services, the service provider is continually billing the credit account by incrementing the mobile customer's account balance due. Then, at the end of the “billing cycle”, the service provider sends the mobile customer an invoice for the balance due.

In the case of a debit account, as the mobile customer utilizes the services, the service provider is continually billing the debit account by decrementing the mobile customer's available balance. Because this debit account is prepaid by the customer, there is no amount due, and no invoices are sent The service provider, however, may optionally notify the mobile customer when the debit account reaches a critically low balance.

In both prior art cases, however, it is necessary that the mobile customer and the service provider have a preestablished financial arrangement of some sort, possibly through a third party. Because of this requirement, the prior art systems have the limitation, as previously described (see FIG. 3), wherein mobile telephony services may be denied to the mobile customer by the service provider, simply because no such pre-established financial arrangement exists.

In contrasts the payment method and system according to the present invention is not based solely on “billing” the mobile customer as mobile services are furnished by the service provider, but also upon payment by the mobile customer at the time the services are provided.

The terms “pay”, “paying”, “paid”, and “payment” herein relate to the transfer, or authorization thereof, from a first party (the “payer”) to a second party (the “payee”) of monetary value in the form of a generally-accepted instrument issued by a governmental authority or governmentally-chartered financial institution (a “recognized” financial institution). A characteristic of a generally-accepted instrument is that it is honored by a recognized financial institution to the credit of the presenter of the instrument. Such generally-accepted instruments include, but are not limited to: electronic funds transfer, electronic stored value, bank account transfers, debit charges, and credit charges. All of the aforementioned instruments can exist and be stored in electronic form and can be readily transferred electronically from one device to another, or can be actualized electronically, such as from a suitably-equipped mobile telephone to a suitably-equipped terminal at a base station. Methods and technology for the transfer and storage of generally-accepted payment instruments in electronic form are well-known in the art and are readily available.

As is customary, payment is contingent on the ultimate validity of the transferred instrument, and thus the payment is not considered to have been made unless the instrument is honored in favor of the payee, such as by a recognized financial institution. Once the instrument is determined to have been valid and the instrument is honored in favor of the payee, however, the time that payment is made is herein defined as the time of transfer, of authorization thereof, from the payer to the payee, regardless of when the instrument's validity is determined or when the payee negotiates or presents the instrument for settlement For example, a payer who authorizes a valid credit charge to a payee is deemed to have made payment at the time of such authorization, irrespective of when the payee sends the credit charge to his bank for processing and settlement and irrespective of when the credit charge is determined to be valid.

Based on the above distinctions, it is seen that prior art payment systems for mobile telephony services are based solely on billing the mobile customer for services as they are furnished by the service provider, whereas the system of the present invention is based on payment by the mobile customer for mobile telephony services as they are furnished by the service provider. It is also seen that this factor, in combination with the widespread availability of recognized banking services for the presenting, accepting, and settlement of generally-accepted payment instruments, accounts for the removal of the principal limitation of prior art systems, as previously described (FIG. 3).

Therefore, according to the present invention there is provided a system for payment for mobile communications services over a public commercial network having a base station, the system including: (a) a mobile telephone having a payment unit operative to paying for the mobile communications services by sending a payment instrument honored by a recognized financial institution; and (b) a point-of-sale terminal cooperative with the base station, the point-of-sale terminal operative to accepting payment for the mobile communications services by receiving, accounting for, and processing the payment instrument.

Furthermore, according to the present invention there is provided a method of payment for mobile communications services over a public commercial network that includes a base station, the payment made by a mobile telephone and received by the base station, the method including the steps of: (a) establishing contact between the mobile telephone and the base station; (b) identifying the mobile telephone and determining that the mobile telephone can make payment; (c) furnishing a unit of mobile telephony service to the mobile telephone by the base station; (d) sending a request for payment for the unit of mobile telephony service from the base station to the mobile telephone; and (e) sending payment for the unit of mobile telephony service from the mobile telephone to the base station.

### BRIEF DESCRIPTION OF THE DRAWINGS

The invention is herein described, by way of example only, with reference to the accompanying drawings, wherein:

FIG. 1 illustrates prior art mobile business relationships on a local level.

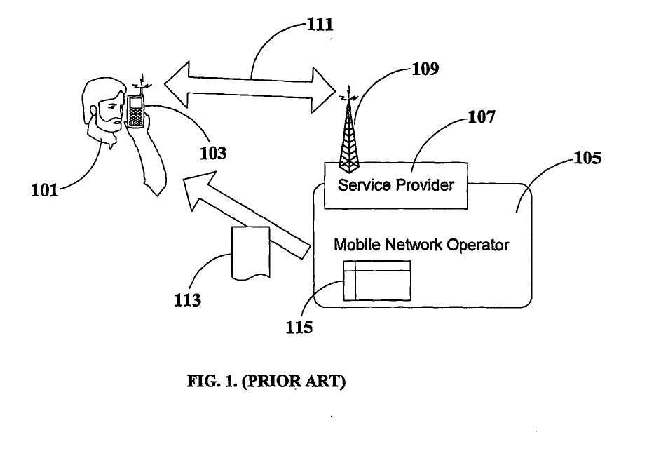

FIG. 2 illustrates prior art mobile business relationships for roaming.

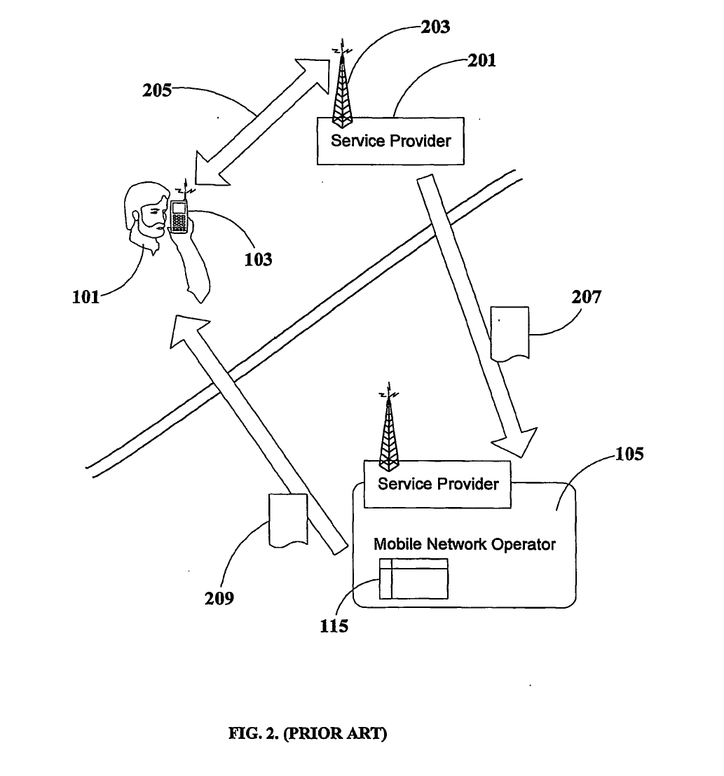

FIG. 3 illustrates a prior art limitation that results in denial of roaming service.

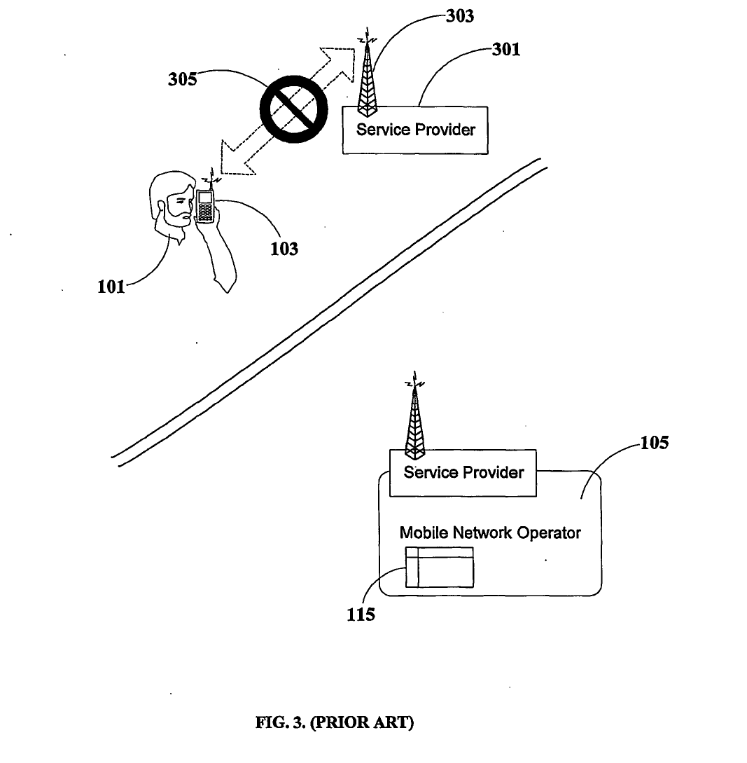

FIG. 4 illustrates a first embodiment of a payment system for mobile telephony services according to the present invention.

FIG. 5 illustrates a mobile telephone having a payment unit according to the present invention.

FIG. 6 illustrates a service provider base station having a point-of-sale terminal according to the present invention.

FIG. 7 illustrates a prior art scheme in which a mobile telephone may be used to make a payment.

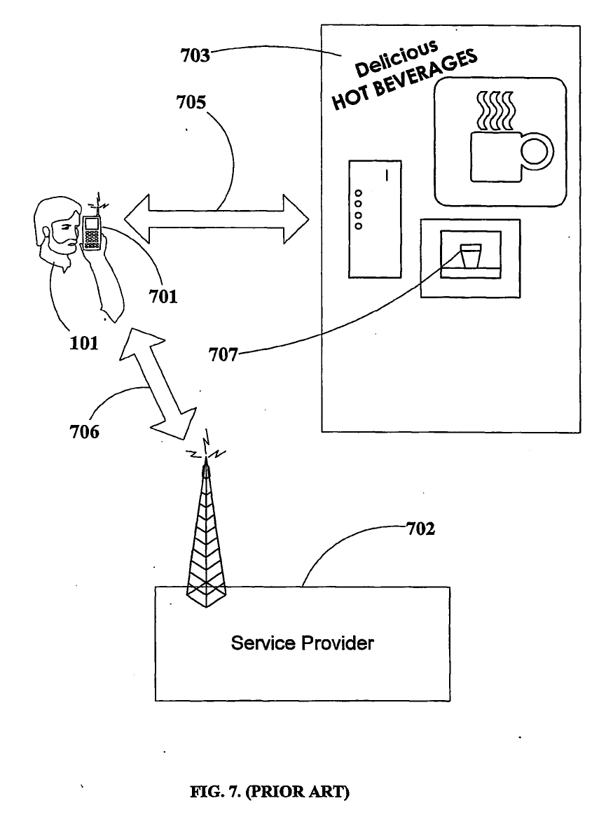

FIG. 8 is a flowchart illustrating the steps of a payment method for mobile telephony services according to the present invention.

FIG. 9 illustrates a second embodiment of a payment system for mobile telephony services according to the present invention.

### DESCRIPTION OF THE PREFERRED EMBODIMENTS

The principles and operation of a payment system for mobile telephony services according to the present invention may be understood with reference to the drawings and the accompanying description. In the descriptions and illustration which follow, the technical aspects of the operation of a mobile telephony system (including the mobile telephones, base stations and networks thereof) are greatly simplified. The present invention relies only on the most basic and general features of a mobile telephony system and does not depend on the detailed technical specifications. The operational principles of cellular mobile telephony systems are well-known, but there are variations in the operation from one such system to another (e.g., analog cellular telephony versus digital cellular telephony, GSK, and so forth). In addition, the present invention is not limited to use with cellular systems, but applies without limitation to all forms of mobile telephony using commercial public mobile telephonic networks.

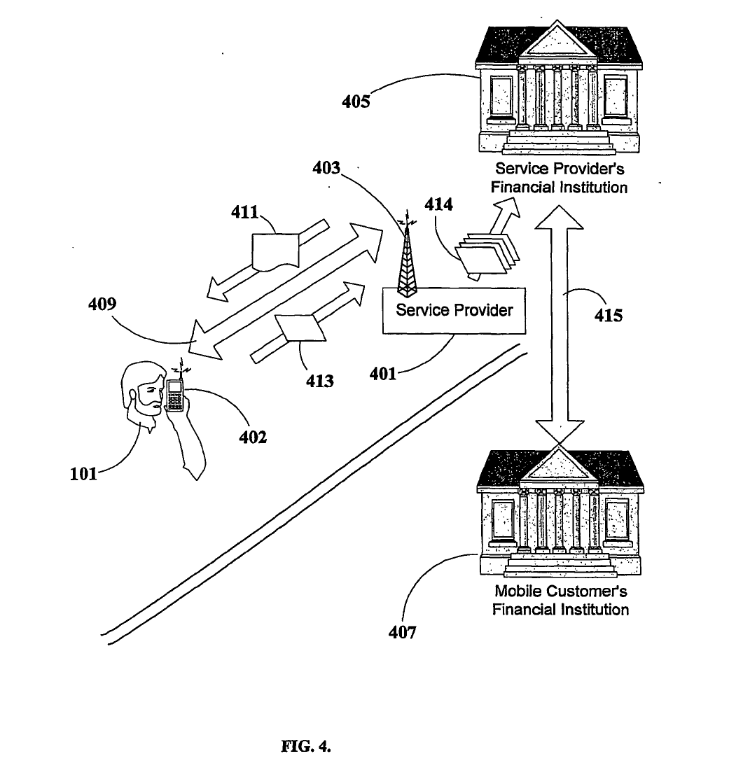

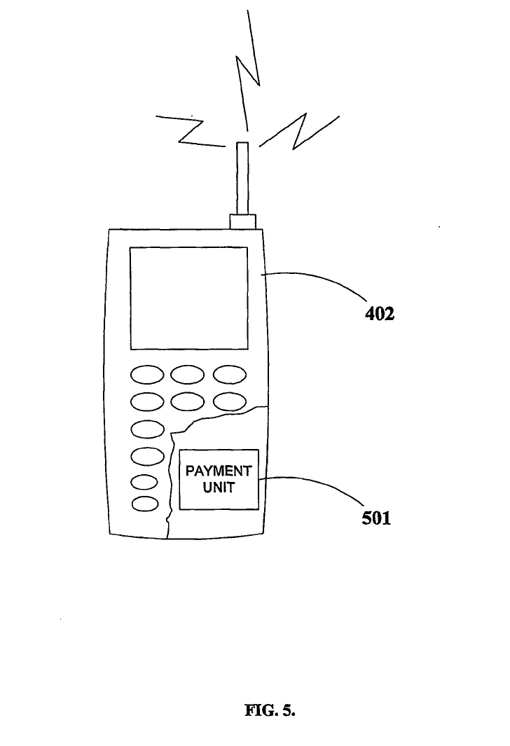

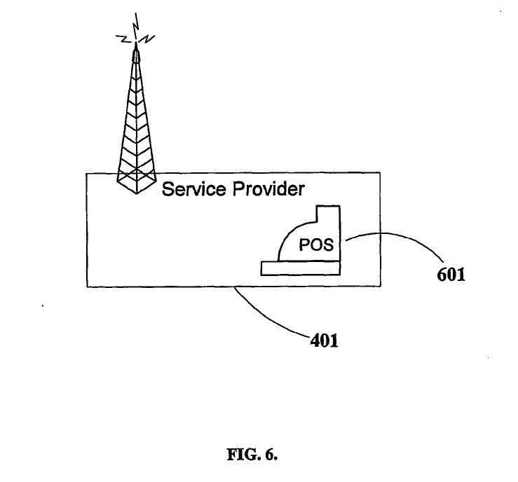

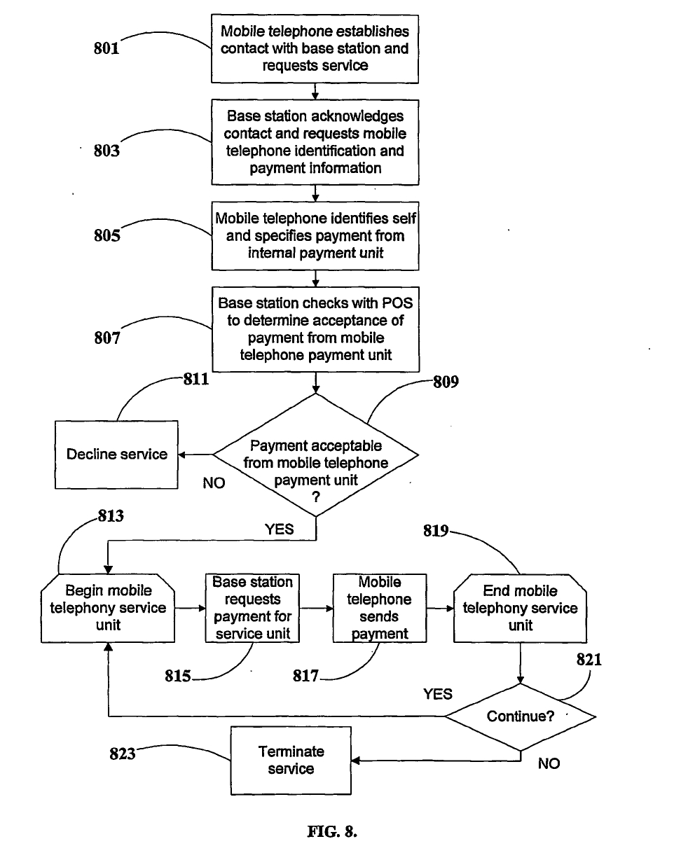

FIG. 8 is a flowchart illustrating the basic method of payment according to the present invention. In a step 801 a mobile telephone (such as mobile telephone 402 of FIG. 4) establishes contact with a base station (such as base station 403 of FIG. 4) and requests mobile telephony service. In a step 803 the base station acknowledges contact and requests identification and payment information from the mobile telephone. In a step 805 the mobile telephone identifies itself and specifies that payment will be made from an internal payment unit (such as payment unit 501 of FIG. 5) in recognized payment instruments as previously described. In a step 807 the base station checks with a point-of-sale (such as POS 601 in FIG. 6) to determine that the mobile telephone's payment instruments will be accepted. In a decision point 809, if the mobile telephone's payment instruments are not acceptable, then service is declined in a step 811. Otherwise, mobile telephony service is initiated at a loop point 813. It is noted that there are many possible variations on the initial “handshaking” protocol just described. The steps can be broken down into more detailed steps, the steps may be combined or arranged somewhat differently, and it is also possible to compress these steps into a fewer number. The essential elements are that the mobile telephone be capable of sending payment instruments to the base station in payment for mobile services at the time those services are furnished, that the base station be capable of accepting those payment instruments, and that the mobile telephone and base station be coordinated in this exchange.

In loop point 813, the base station provides a unit of mobile telephony service to the mobile telephone. What constitutes a “service unit”, however, is determined by the service provider. A service unit may be based on time, applicable tariffs, and other factors. However defined, a service unit may be charged to the mobile telephone at some point after initiation and prior to completion. As illustrated, in a step 815 the base station requests payment for the service unit, and immediately thereafter the mobile telephone sends a payment instrument to the base station in a step 817. At a concluding point 819 of the service unit, a decision point 821 determines whether mobile telephony service is to continue. There are several different conditions which preclude the continuation of service, and if one or more of these conditions prevail, then at a step 823 mobile telephony service is terminated. Examples of such conditions for the termination of service include, but are not limited to the following: the mobile customer may have completed his or her conversation and “hung up” the mobile telephone; the session may have been interrupted by loss of radio contact with the mobile telephone; the mobile telephone may have left the local area served by the base station and may have requested service from another base station; the mobile telephone may have failed to send in payment for services as requested in step 815. If, however, it is determined in decision point 821 that service should continue, another service unit is provided at loop point 813.

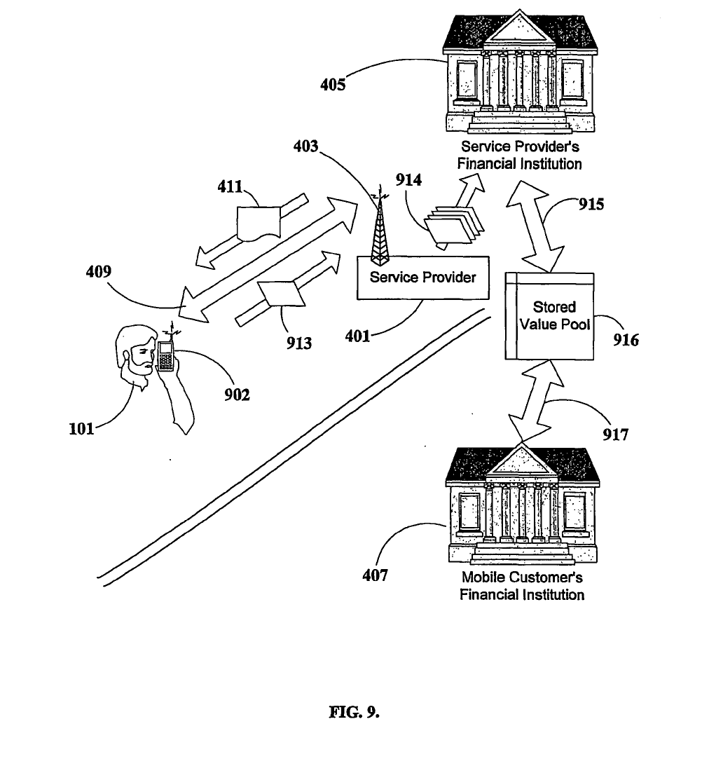

FIG. 9 illustrates another embodiment of the present invention which employs stored value as the payment instrument. A mobile telephone 902 has a payment unit (such as payment unit 501 of FIG. 5) that is capable of paying with stored value issued by a recognized financial institution from a stored value pool 916. This stored value is expressed in terms of electronic tokens representing monetary value, as is well-known in the art. Stored value is sent from mobile telephone 902 to base station 403, which accumulates the stored value in a point-of-sale (such as POS 601 in FIG. 6) which is capable of handling and settling stored value. Service provider 401 sends accumulated stored value 914 to financial institution 405, which transfers stored value via a channel 915 to stored value pool 916. Financial institution 407 is the financial institution of customer 101, and also has a channel 917 to stored value pool 916. In this way, financial institution 407 is able to obtain stored value to place into mobile telephone 902.

The payment method disclosed in U.S. Pat. No. 5,744,787 (hereinafter referred to as '787), as previously noted, provides another embodiment of the present invention. As therein disclosed, payment can be made by means of electronic wallet 9 (FIG. 4 of '787) which contains an electronic purse, an electronic checkbook, and an external interface to payment terminal 21 (also in FIG. 4 of '787). The system and method disclosed in '787 combines the use of stored value for paying small amounts with the use of conventional payment instruments (such as credit and debit charges) for larger amounts, and one advantage thereof is that stored value is replenished automatically into the electronic purse and does not need to be reloaded separately, as described above in conjunction with the system illustrated in FIG. 9. Accordingly, electronic wallet 9 of '787 can be used in the present invention as payment unit 501 (FIG. 5), and payment terminal 21 of '787 can be used as POS 601 (FIG. 6).

While the invention has been described with respect to a limited number of embodiments, it will be appreciated that many variations, modifications and other applications of the invention may be made.

What is claimed is:

1. A system for payment for mobile communications services over a public commercial network having a base station, the system comprising:
(a) a mobile telephone having a payment unit operative to paying for the mobile communications services by sending a payment instrument honored by a recognized financial institution; and
(b) a point-of-sale terminal cooperative with the base station, said point-of-sale terminal operative to accepting payment for the mobile communications services by receiving, accounting for, and processing said payment instrument.

2. The system of claim 1, wherein said mobile telephone transfers said payment instrument upon receiving a request for payment from the base station.

3. The system of claim 2, wherein the base station provides mobile telephony services to said mobile telephone, and said request for payment is done at the time of providing said mobile telephony services.

4. The system of claim 1, wherein said payment instrument is included in the group containing debit charge, credit charge, electronic funds transfer, account-to-account transfer, and stored value.

5. The system of claim 1, wherein said payment unit comprises an electronic wallet containing an electronic purse and an electronic checkbook.

6. A method of payment for mobile communications services over a public commercial network that includes a base station, the payment made by a mobile telephone and received by the base station, the method comprising the steps of:
(a) establishing contact between the mobile telephone and the base station;
(b) identifying the mobile telephone and determining that the mobile telephone can make payment;
(c) furnishing a unit of mobile telephony service to the mobile telephone by the base station;
(d) sending a request for payment for said unit of mobile telephony service from the base station to the mobile telephone; and
(e) sending payment for said unit of mobile telephony service from the mobile telephone to the base station.

7. The method of claim 6, wherein the payment is in the form of an instrument honored by a recognized financial institution.

8. The method of claim 6, wherein said sending a request for payment and said sending payment are done at the time of said furnishing said unit of mobile telephony service.
